(19) United States
(12) Patent Application Publication
(10) Pub. No.: US 2025/0027647 A1
(43) Pub. Date: Jan. 23, 2025

(54) APPARATUS AND PROCESS FOR REDUCED FORMATION OF NITROGEN OXIDES DURING COMBUSTION

(71) Applicant: Air Products and Chemicals, Inc., Allentown, PA (US)

(72) Inventors: Carmine Iandoli, Barcelona (ES); David Ross Graham, Harleysville, PA (US); Eugene S. Genkin, Allentown, PA (US)

(73) Assignee: Air Products and Chemicals, Inc., Allentown, PA (US)

(21) Appl. No.: 18/498,539

(22) Filed: Oct. 31, 2023

Related U.S. Application Data
(60) Provisional application No. 63/527,810, filed on Jul. 19, 2023.

(51) Int. Cl. F23L 7/00

(52) U.S. Cl. CPC F23L 7/00; F23L 2900/07001

(57) ABSTRACT

An apparatus and process can be configured for reduced nitrogen oxide formation during combustion. Embodiments can provide synthetic air to a combustion device so that combustion of a fuel can occur with a substantially low amount of NOx. Some embodiments can provide a reduction in NOx formation by at least 75% and as much as greater than 95% as compared to use of ambient air or oxygen enriched air oxidants. Embodiments can also provide a flue gas that has a high concentration of carbon dioxide that can facilitate improved carbon capture and permit efficient formation of at least one carbon dioxide product stream with a high carbon dioxide concentration (e.g. at least 95 mole percent carbon dioxide).

### CROSS-REFERENCE TO RELATED APPLICATIONS

The present application claims priority to U.S. Provisional Patent Application No. 63/527,810, filed on Jul. 19, 2023.

### FIELD

The present innovation relates to processes and apparatuses for reduced formation of nitrogen oxides (NOx) during combustion. For example, embodiments can be configured for forming and using synthetic air as an oxidant for combustion of a fuel (e.g. a hydrocarbon, a mixture of hydrocarbons, etc.) to reduce nitrogen oxide formation during combustion.

### BACKGROUND

A combustion process can be utilized in various industrial settings. For example, a combustion process can be utilized in a process to generate electricity, utilized in a gasification process, utilized in a steam/hydrocarbon reforming process, utilized for furnace operations to heat a material or melt a material, utilized in a boiler operation, or can be utilized in a process to generate power. Examples of combustion processes and examples of fuels and oxidant flows that can be used in combustion processes are disclosed in U.S. Pat. Nos. 11,592,178, 8,808,425, 8,715,617, 8,496,908, 7,850,763, 7,303,388, and 4,495,874 and Chinese Patent Application Publication No. CN 110220378.

### SUMMARY

Industrial fired heaters can emit a high amount of nitrogen oxides (which can also be referred to as NOx, NOx, or NOX). Such heaters can utilize one or more burners that can use a fuel and/or an oxidant for being combusted in a combustor or combustion chamber to generate heat. The resulting combustion can often result in substantial and undesired amounts of NOx, such as NO, NO₂, N₂O, N₂O₃, and other nitrogen oxides. Carbon dioxide (CO2) is also formed during the combustion process when a hydrocarbon fuel is being combusted.

Often, a catalytic reduction, advanced burner configuration, or both are employed to try to reduce NOx emissions. However, catalytic reduction often requires use of ammonia (NH₃) or urea (CH₄N₂O) and can require a large amount of catalyst and can require a significant increase in operational costs. Also, the use of ammonia can result in the ammonia slipping into flue gas or other fluid, which can pose equipment degradation issues, environmental concerns, and other problems. Advanced burners can often also require use of increased capital costs associated with the installation and use of such burners. These approaches can also reduce operational flexibility and can require combustion processes to have to incur more maintenance operations.

We determined that reduced NOx formation from combustion of a hydrocarbon fuel can be provided without the use of catalytic reduction and without use of an advanced burner. While an advanced burner could be utilized due to other design requirements, one is not needed to account for reducing NOx emissions in embodiments of our apparatus and process for combustion of a fuel with reduced NOx emissions. Embodiments can permit NOx scrubbers to be avoided or can permit such NOx scrubbers to be provided with smaller sizing to provide further enhanced NOx reductions as well. Further, we have surprisingly found that embodiments can be provided so that a substantial reduction in CO2 emissions can also be provided via implementation of different types of carbon capture equipment and/or can permit CO2 scrubbing equipment to be eliminated and/or reduced in size.

Embodiments have been surprisingly found to be able to drastically reduce NOx formation that can occur during combustion and, consequently, also significantly reduce NOx emissions. For instance, we have found that some embodiments of our process and apparatus can provide an 80% to 98% reduction in NOx formation or at least a 75% reduction in NOx formation from the combustion of fuel (e.g. methane, oil, refinery off gas, pulverized coal, refinery off gas, pressure swing adsorption (PSA) system tail gas, a hydrocarbon, mixtures thereof, etc.). We have found that this type of significant NOx reduction can be provided regardless of the type of burner or burner assembly that may be used in the combustion process.

In some embodiments, NOx formation can be reduced such that no more than 15 mg/Nm³ of NOx is formed\ (where Nm³ is a normal cubic meter, which is a volume of gas that occupied 1 cubic meter (m³) under conditions in which the gas is absolutely dry, at a temperature of 0° C. and at an absolute pressure of 1 atm). For instance, embodiments can be provided so that NOx formation is in a range of 15 mg/Nm³ of NOx to greater than 0 mg/Nm³ of NOx. Other embodiments can be configured so that NOx formation is in a range of 12 mg/Nm³ of NOx to greater than 0.2 mg/Nm³ of NOx or 10 mg/Nm³ of NOx to greater than 0.4 mg/Nm³ of NOx. Yet other embodiments can be configured so that NOx formation is in a range of 6.1 mg/Nm³ of NOx to 0.8 mg/Nm³ of NOx or 6.1 mg/Nm³ of NOx to greater than 0 mg/Nm³ of NOx. Yet other embodiments can be configured so that NOx formation is at or below 2.5 parts per million by volume dry (ppmvd) NOx or is in a range of between 2.8 mg/Nm³ NOx and 2.6 mg/Nm³ NOx.

In a first aspect, an apparatus for reduced nitrogen oxide formation during combustion can include a mixing device configured to mix flue gas and oxygen to form a synthetic air for feeding to a combustion device as an oxidant for combustion of a fuel fed to the combustion device. The mixing device can be positionable to receive a gas from at least one source of gas having carbon dioxide (CO2) and/or flue gas output from the combustion device that is recycled to the mixing device. The mixing device can also be positioned to receive the oxygen from at least one source of oxygen. The synthetic air can be formed so that the synthetic air has a concentration of oxygen (O2) of between 20 mole percent (mol %) 02 and 40 mol % O2, has a concentration of nitrogen (N2) of between 20 mol % N2 and 0 mol % N2, and a concentration of CO2 of at least 30 mol % CO2.

In some embodiments of the apparatus, the mixing device can feed the formed synthetic air to at least one burner of the combustion device. In some embodiments, the burner can pre-mix at least some of the synthetic air with fuel for injecting into the combustion chamber of the combustion device for combustion of the fuel. At least one other portion of the oxidant can be injected via the burner downstream of where the fuel and synthetic air mixture is injected to facilitate further combustion of the fuel or complete combustion of the fuel. Other embodiments may be configured so that the formed synthetic air is fed to the combustion chamber separate from the fuel or so that some of the formed synthetic air is fed to one or more burners for injection with fuel while another portion of the formed synthetic air is fed to the combustion chamber without being pre-mixed with fuel.

The combustion device can be included in embodiments of the apparatus. In some configurations, the combustion device can be configured as a stream reformer, gas turbine, furnace, or boiler.

For example, in a second aspect, the apparatus can include the combustion device. The combustion device can be configured to receive the synthetic air output from the mixing device as an oxidant for combustion of a fuel to form flue gas. In some configurations, the combustion device can include at least one burner for injection of fuel and the synthetic air into the combustion chamber of the combustion device for combustion of the fuel, for example.

In a third aspect, the apparatus can include a carbon capture apparatus positioned to receive a first portion of the flue gas output from the combustion device. In some embodiments, the mixing device can be positioned to receive a second portion of the flue gas output from the combustion device for forming the synthetic air. The second portion of the flue gas can be between 30% and 70% of the flue gas output from the combustion device and a balance of the flue gas is the first portion of the flue gas. In other embodiments, the second portion of the flue gas can be between 40% and 60% of the flue gas output from the combustion device and the balance of the flue gas is the first portion of the flue gas feedable to the carbon capture system.

In a fourth aspect, the synthetic air can include other constituents or other content ranges for different constituents. For example, the formed synthetic air can have between 0 mol % water and 40 mol % water, 2 mol % water and 40 mol % water, or between 5 mol % water and 40 mol % water. As another example, the synthetic air can have a CO2 concentration of between 30 mol % CO2 and 70 mol % CO2 or between 30 mol % CO2 and 60 mol % CO2. As yet another example, the O2 content can be between 22 mol % O2 and 28 mol % O2, between 20 mol % O2 and 35 mol % O2, or between 24 mol % O2 and 28 mol % O2 in some embodiments. As yet another example, the N2 content can be between 5 mol % and 20 mol %, 5 mol % and 15 mol %, or between 0 mol % and 15 mol %. The synthetic air can also have a pre-selected ratio of water to CO2 of between 0.5 and 1.0 or can be between 0 and 1.1, or can be between 0.7 and 0.9.

In a fifth aspect, the synthetic air can be formed such that combustion of the fuel at full rate operation with the synthetic air results in formation of nitrogen oxides (NOx) that is no more than 15 mg/Nm³ of NOx and is also greater than 0 mg/Nm³ of NOx, wherein Nm³ is a normal cubic meter. In some embodiments, the synthetic air can be formed so that combustion of the fuel at full rate operation with the synthetic air results in formation of nitrogen oxides (NOx) that is no more than 6.1 mg/Nm³ of NOx and is also greater than 0 mg/Nm³ of NOx, for example. Other embodiments can be configured so that the synthetic air can be formed so that combustion of the fuel at full rate operation with the synthetic air results in formation of nitrogen oxides (NOx) that is no more than 10 mg/Nm³ of NOx and is also greater than 0 mg/Nm³ of NOx.

In a sixth aspect, the at least one source of oxygen can be oxygen from an air separation unit (ASU), vacuum swing adsorption (VSA) unit, and/or a storage tank configured to retain oxygen. The oxygen content of the source of oxygen can be mostly O2. For example, the O2 content of the source of oxygen can be between 85 mol % O2 and 100 mol % O2, or be at least 85 mol % O2, between 90 mol % O2 and 99.99 mol % O2, or other suitable content range for 02 for mixing with other gas and/or the flue gas to form the synthetic air.

In a seventh aspect, the apparatus of the first aspect can include one or more features of the second aspect, third aspect, fourth aspect, fifth aspect and/or sixth aspect. Other embodiments can also include other features or combinations of features. Examples of such other features are provided in the discussion of exemplary embodiments of different embodiments of the apparatus provided herein, for example.

For example, the apparatus for reduced nitrogen oxide formation during combustion can include a mixing device configured to mix flue gas and oxygen to form a synthetic air for feeding to a combustion device as an oxidant for combustion. The mixing device can be positionable to receive the flue gas from at least one source of gas having CO2 and/or flue gas output from the combustion device that is recycled to the mixing device. The mixing device can be positioned to receive the oxygen from at least one source of oxygen. The synthetic air can have a concentration of 02 of between 20 mol % O2 and 40 mol % O2, a concentration of N2 of between 20 mol % N2 and 0 mol % N2, and a concentration of CO2 of between 30 mol % CO2 and 80 mol % CO2. The combustion device can be connected to the mixing device to receive the synthetic air from the mixing device as the oxidant for combustion of a fuel. The combustion device can have at least one burner and a flue gas outlet conduit for outputting flue gas formed from the combustion. A carbon capture apparatus can be positioned to receive a first portion of the flue gas from the flue gas outlet conduit to form at least one CO2 product stream having a concentration of CO2 between 90 mol % CO2 and 100 mol % CO2. The mixing device can be positioned to receive a second portion of the flue gas from the flue gas outlet conduit to form the synthetic air. The synthetic air can be formable such that combustion of the fuel at full rate operation with the synthetic air results in formation of nitrogen oxides (NOx) that is no more than 15 mg/Nm³ of NOx and is also greater than 0 mg/Nm³ of NOx, wherein Nm³ is a normal cubic meter. The first portion of the flue gas can be between 30% and 70% of the flue gas and the second portion is a remaining portion of the flue gas that is not passed to the carbon capture apparatus (e.g. can be passed to the mixing device).

In an eighth aspect, a process for reduced nitrogen oxide formation during combustion is provided. The process can include forming a synthetic air by mixing a gas having CO2 and/or flue gas recycled from a combustion device with oxygen from at least one source of oxygen. The synthetic air can have between 0 mol % N2 and 20 mol % N2. The process can also include feeding the formed synthetic air to the combustion device as an oxidant for combustion of a fuel in a combustion chamber of the combustion device.

Embodiments of the apparatus for reduced nitrogen oxide formation can be configured to implement an embodiment of the process. Embodiments of the process can also be configured such that the synthetic air has other constituents or ranges of constituents. For example, the synthetic air can have a concentration of O2 of between 20 mol % O2 and 40 mol % O2, a concentration of N2 of between 20 mol % N2 and 0 mol % N2, a concentration of CO2 of at least 30 mol % CO2, and a concentration of water of between 2 mol % water and 40 mol % water. As another example, the CO2 content of the synthetic air can be between 30 mol % CO2 and 80 mol % CO2, between 30 mol % CO2 and 70 mol % CO2, or between 30 mol % CO2 and 60 mol % CO2. As another example, the N2 content can be between 0 mol % N2 and 15 mol % N2 or between 0 mol % N2 and 10 mol % N2. As yet another example, the water content can be between 0 mol % water and 40 mol % water. As yet another example, the synthetic air can also have a pre-selected ratio of water to CO2 of between 0.5 and 1.0 or can be between 0 and 1.1, or can be between 0.7 and 0.9.

In a ninth aspect, the process can include feeding a portion of flue gas formed via the combustion of the fuel in the combustion chamber of the combustion device to a mixing device for formation of the synthetic air and/or to a carbon capture apparatus to form at least one carbon dioxide product stream. For example, in some embodiments, the process can include feeding a first portion of flue gas formed via the combustion of the fuel in the combustion chamber of the combustion device to a carbon capture apparatus to form at least one carbon dioxide product stream and feeding a second portion of flue gas formed via the combustion of the fuel in the combustion chamber of the combustion device to a mixing device for formation of the synthetic air. Other embodiments can include feeding a portion of the flue gas to the mixing device or feeding a portion of the flue gas to a carbon capture apparatus.

In a tenth aspect, the process can include feeding the oxygen to the mixing device for the forming of the synthetic air. The oxygen can be from a source of oxygen, such as oxygen output from an ASU, VSA unit, or a tank storing oxygen. The oxygen content from the source of oxygen can be at least 85 mol % O2, or between 85 mol % O2 and 100 mol % O2 in some embodiments.

In an eleventh aspect, the process can include combusting the fuel in presence of the synthetic air as an oxidant for the combusting of the fuel such that formation of nitrogen oxides (NOx) from combusting of the fuel during full rate operation is no more than 15 mg/Nm³ of NOx and is also greater than 0 mg/Nm³ of NOx, wherein Nm³ is a normal cubic meter. In some embodiments, less than 15 mg/Nm³ can be created. For example, in some embodiments, the combusting of the fuel in presence of the synthetic air as an oxidant for the combusting of the fuel can be performed such that formation of NOx from combusting of the fuel during full rate operation is no more than 6.1 mg/Nm³ of NOx and is also greater than 0 mg/Nm³ of NOx, wherein Nm³ is a normal cubic meter.

In a twelfth aspect, the process of the eighth aspect can include one or more features of the ninth aspect, tenth aspect, and/or eleventh aspect. Other embodiments can also include other features or combinations of features. Examples of such other features are provided in the discussion of exemplary embodiments of different embodiments of the process provided herein, for example. Embodiments of the process can also include features of an embodiment of the apparatus for reduced nitrogen oxide formation during combustion.

It should be appreciated that embodiments of the process and apparatus can utilize various conduit arrangements and process control elements. The embodiments may utilize sensors (e.g., pressure sensors, temperature sensors, flow rate sensors, concentration sensors, etc.), controllers, valves, piping, and other process control elements. Some embodiments can utilize an automated process control system and/or a distributed control system (DCS), for example. Various different conduit arrangements and process control systems can be utilized to meet a particular set of design criteria.

Other details, objects, and advantages of our apparatus for reduced nitrogen oxide formation during combustion, process for reduced nitrogen oxide formation during combustion, and methods of making and using the same will become apparent as the following description of certain exemplary embodiments thereof proceeds.

### BRIEF DESCRIPTION OF THE DRAWINGS

Exemplary embodiments of our apparatus for reduced nitrogen oxide formation during combustion, process for reduced nitrogen oxide formation during combustion, and methods of making and using the same are shown in the drawings included herewith. It should be understood that like reference characters used in the drawings may identify like components.

FIG. 1 is a block diagram of a first exemplary embodiment of an apparatus for reduced nitrogen oxide formation during combustion.

FIG. 2 is a block diagram of a first exemplary embodiment of a process for reduced nitrogen oxide formation during combustion. The first exemplary embodiment of the apparatus for reduced nitrogen oxide formation during combustion can implement this first exemplary embodiment of the process for reduced nitrogen oxide formation during combustion.

### DETAILED DESCRIPTION

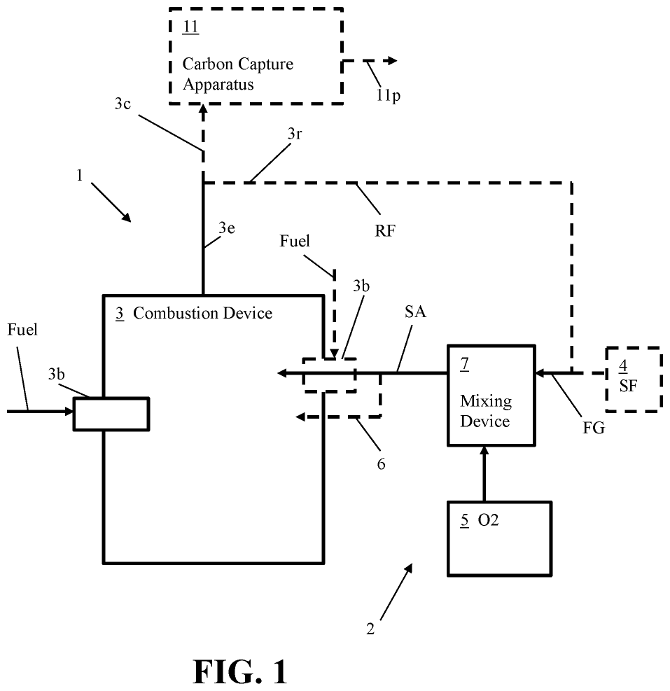

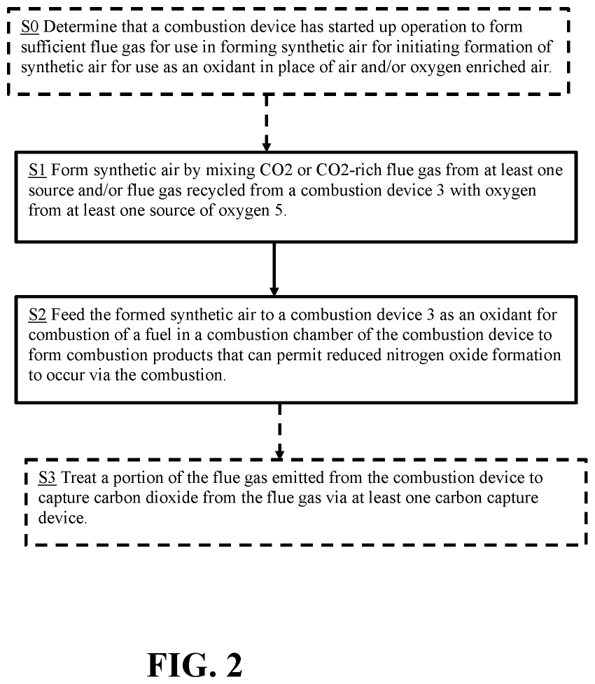

Referring to FIGS. 1 and 2, an apparatus 1 for reduced nitrogen oxide formation during combustion can include a combustion device 3 that can have one or more burners 3b. The burners can emit fuel into a combustion chamber for combustion therein. The fuel can include a hydrocarbon fuel (e.g. pulverized coal, oil, natural gas, refinery off-gases, etc.) and/or other fuel (e.g. hydrogen) that can be provided by a pipeline, an industrial process element, a fuel storage unit, or other source of fuel.

Each burner 3b can also receive a flow of oxidant for feeding into the combustion chamber with the fuel. Alternatively (or in addition) at least one oxidant flow can be fed into the combustion chamber upstream or downstream of the burners to facilitate combustion of the fuel therein. Combustion of the fuel can generate heat and form a flue gas that includes the combustion products of the combusted fuel. The combustion products included in the flue gas can include water, carbon dioxide and small amounts of carbon monoxide. The flue gas can also include nitrogen oxides (NOx).

In some embodiments, the combustion device 3 can be configured to heat a feed that may be fed to the combustion device. The feed can be, for example, water for generation of steam. As another example, the feed can be a material to be heated via the combustion for generation of a reaction to form one or more desired products. In yet other embodiments, the combustion device 3 can be a boiler for forming steam or a furnace that is configured to provide heat for melting glass, metal, or other material. Embodiments of the combustion device 3 can be configured to facilitate generation of power, generation of electricity, facilitate a steam/hydrocarbon reforming process, or be utilized in another process in which combustion is desired. For instance, the combustion device 3 can be or include a gas turbine, a furnace, a boiler, a steam reformer, or a methane steam reformer. The combustion device 3 can also be other types of combustors or devices used in combustion based processes that use an oxidant to combust a fuel.

Each burner 3b of the combustion device 3 can be any type of suitable burner or arrangement of burners. Some embodiments of the combustion device 3 can have a single burner. Other embodiments can utilize a plurality of burners. Each burner 3b can include a nozzle arrangement for feeding fuel or a mixture of fuel and an oxidant into the combustion chamber for combustion therein. Different types of burners 3b can be utilized. For instance, staged non-premixed oxidant burners can be used or an oxidant pre-mixed burner can be used. It should be appreciated that any type of burner can be utilized as a burner 3b.

In some embodiments, each burner 3b can be configured as an air staged burner. For example, the burner 3b can be configured to receive oxidant supplied through multiple stages. At least one of these stages can be configured for pre-mixing with fuel before that fuel is fed with the oxidant mixed with it into the combustion device for combustion. An additional stage can optionally be provided for injecting just the oxidant into the combustion chamber downstream of the fuel injection to react with partially combusted fuel for complete combustion. In some embodiments, the multiple stages of the burner 3b can include a first stage in which fuel is pre-mixed with oxidant and a second stage in which the oxidant/fuel mixture is premixed with additional oxidant. In a third stage, just oxidant can be injected downstream of the fuel/oxidant mixture injection for providing additional oxidant to facilitate complete combustion or further combustion of the fuel in the combustion chamber of the combustion device. In some configurations, 60% to 80% of the oxidant to be fed into the combustion device can be provided in the first and second stages of oxidant pre-mixing stage and 20%-40% of the oxidant can be fed into the combustion device via the third stage.

It should be appreciated that other embodiments of the burner 3b can have other configurations. For instance, the mixing stages can differ or there may not be any oxidant/fuel mixing stages. For instance, some embodiments can be configured so fuel is injected separately from the oxidant.

In yet other embodiments, oxidant staging can occur so that only a single stage of pre-mixing fuel with oxidant is provided and a second stage is provided for injection of oxidant downstream of the fuel/oxidant mixture injection for facilitating further combustion of the fuel. Other types of burner configurations may also be utilized in other embodiments. In embodiments that may only have a single stage of pre-mixing of oxidant and fuel, the first stage of pre-mixing can receive 50% to 80% of the oxidant to be fed into the combustion device and a second stage can output 20% to 50% of the oxidant downstream of the injection of the fuel to facilitate further combustion or complete combustion of the fuel. Other embodiments may utilize different proportions of oxidant for pre-mixing with fuel and downstream injection for facilitating complete combustion.

At least one flow of oxidant can be provided to the combustion device 3 to facilitate combustion of a fuel therein. For example, oxidant can be fed to at least one burner 3b for combustion of the fuel.

The oxidant can be a flow of synthetic air SA, which can be formed and used so that the use of ambient air or oxygen enriched air can be avoided. For example, while initial combustion of a fuel within a combustion chamber of the combustion device 3 during an initial start-up may be provided via air or oxygen enriched air, after initial start-up has progressed, the oxidant used for combustion can be changed to synthetic air so that the use of air or oxygen enriched air can be stopped and no longer used for providing an oxidant for combustion. Instead, after the switchover to synthetic air SA, only a formed synthetic air SA can be provided as the oxidant to the combustion device 3 for combustion of the fuel.

In other embodiments, even the start-up of the combustion device 3 may be provided by use of the synthetic air SA such that no use of air or oxygen enriched air is utilized. For example, a source gas having CO2 4 (SF) used for formation of the synthetic air can be another plant process and the flue gas may be sufficiently present at the start-up of the combustion device 3 (e.g. via storage in a storage tank and/or via being provided by this process element) that there is no need for any air or oxygen enriched air to be utilized.

For instance, CO2 from an external source (e.g. a pipeline or plant process) or a CO2 storage device (e.g. CO2 storage tank) can be a source of gas having CO2 that can be in fluid communication with the mixing device 7 for feeding CO2 to the mixing device for use in making synthetic air during start-up. As another example, CO2-rich flue gas generated with synthetic air having a low N2 concentration (e.g. less than 20 mol % N2) from another process can also, or alternatively, be utilized as a source of gas having CO2 4 for being fed to the mixing device 7 for use in forming the synthetic air SA.

The synthetic air SA can be formed via a mixing device 7 as noted above. The mixing device 7 can receive flue gas FG for forming the synthetic air. The flue gas can include a gas having CO2 and low N2 from at least one source of gas having CO2 (SF) and/or a recycle stream of flue gas that can be recycled from flue gas formed from combustion in the combustion device 3 that can be emitted from the combustion device 3 via a flue gas conduit 3e. As noted above, the source of gas having CO2 4 (SF) can include CO2 from a source of CO2 (e.g. a CO2 pipeline, a CO2 compressor, CO2 pump, or CO2 storage tank, etc.) and/or a CO2-rich flue gas from an industrial plant element or an industrial plant process unit that can generate a CO2-rich flue gas via combustion or other process and be connected to the mixing device 7 for feeding that CO2-rich flue gas to the mixing device. The source of gas having CO2 can include a gas having a significant amount of CO2 (e.g., between 30 mole percent (mol %) CO2 and 100 mol % CO2) and a relatively low amount of N2 (e.g. between 0 mol % N2 and 20 mol % N2). The source of gas having CO2 can also include water and other constituents in some embodiments. For example the source of gas having CO2 can have between 0 mol % water and 40 mol % water, between 0 mol % Ar and 3 mol % Ar, and between 0 mol % CO and 2 mol % CO.

The flue gas FG fed to the mixing device 7 to form the synthetic air SA can also, or alternatively, include flue gas formed in the combustion device 3 that is subsequently fed to the mixing device 7 as recycled flue gas RF via a flue gas recycle conduit 3r connected between the mixing device 7 and the flue gas outlet conduit 3e of the combustion device 3.

The exact composition of the flue gas FG can be different based on the type of industrial process that is utilized to generate the flue gas FG and/or the type of fuel being combusted to form the flue gas FG. In many embodiments, the flue gas FG can include carbon dioxide and water, as well as other constituents (e.g. carbon monoxide, argon, nitrogen, oxygen etc.). The carbon dioxide can be a significant portion of the flue gas (e.g. between 40 mol % and 70 mol % of the flue gas). The flue gas can also have between 30 mol % and 60 mol % water and between 0 mol % nitrogen to 30 mol % nitrogen and between 0 mol % and 10 mol % oxygen.

The flue gas FG can also include argon, helium, carbon monoxide, oxygen, or other constituents. For instance, the flue gas can have between 0 mol % argon and 5 mol % argon, between 0 mol % carbon monoxide and 0.5 mol % carbon monoxide, between 0 mol % helium and 1 mol % helium, and between 0 mol % and 10 mol % oxygen.

The mixing device 7 can also receive oxygen (O2) gas from at least one source of oxygen 5 (O2) for mixing with the flue gas FG to form synthetic air SA to be fed to the combustion device 3 as an oxidant flow. The oxygen can be 100 mol % oxygen, or can be between 100 mol % oxygen and 98 mol % oxygen, between 98 mol % oxygen and 95 mol % oxygen, or can be between 85 mol % oxygen and 100 mol % oxygen. In other embodiments, the oxygen of the source of oxygen can have another suitable oxygen concentration as well.

The source of oxygen 5 can include, for example, liquid oxygen stored in a cryogenic oxygen storage tank that can be vaporized and subsequently fed to an optional buffer tank for feeding to the mixing device 7, oxygen gas stored in an oxygen storage tank, oxygen output from an air separation unit (ASU), oxygen formed from a vacuum swing adsorption (VSA) process, or other suitable source of oxygen gas.

The formed synthetic air SA can have a significant amount of carbon dioxide (CO2) as well as between 20 mol % O2 and 30 mol % O2, between 20 mol % O2 and 35 mol % O2, or between 22 mol % O2 and 40 mol % O2. For example, the CO2 content of the formed synthetic air SA can be between 30 mol % and 80 mol % or between 30 mol % and 60 mol %. Water (H2O) can also be included in the formed synthetic air to help inhibit NOx formation from combustion within the combustion chamber of the combustion device 3. The water can be between 2 mol % and 40 mol % of the synthetic air SA in some embodiments. In other embodiments, water may not be present or may only be present in a relatively trace amount (e.g. water can be between 0 mol % and 5 mol % of the synthetic air SA).

In some embodiments, the synthetic air SA can be formed so that there is a pre-selected ratio of water to CO2 (water/CO2). This pre-selected ratio can be 0.8, between 0 and 1.1, or between 0.7 and 0.9 in some embodiments. Other embodiments can also utilize another suitable ratio that may be configured to meet a particular set of design criteria.

The water included in the synthetic air SA can include water in the flue gas. In some embodiments, the water can also be provided by injecting water from a source of water into the flue gas via the mixing device 7 or a water injection mechanism positioned upstream of the mixing device 7.

The formed synthetic air can have a low amount of nitrogen therein that is much lower than the nitrogen content in air or oxygen enriched air. For example, the formed synthetic air SA can include between 20 mol % oxygen (O2) and 40 mol % O2, between 0 mol % argon (Ar) and 2 mol % Ar, between 2 mol % nitrogen (N₂) and 20 mol % N2, between 5 mol % water and 40 mol % water, and between 30 mol % carbon dioxide (CO2) and 80 mol % CO2. The formed synthetic air SA can also include other constituents such as small or trace amounts of carbon monoxide (CO) and helium (He), for example.

For instance, the mixing device 7 can be configured for use of the oxygen and flue gas for formation of synthetic air SA that can include 30 mol % CO2 to 60 mol % CO2, 21 mol % O2 to 28 mol % O2, 1 mol % Ar to 2 mol % Ar, 5 mol % N2 to 15 mol % N2, and 5 mol % water to 40 mol % water. As another example, the mixing device 7 can be configured for use of the oxygen and flue gas for formation of synthetic air SA that can include 30 mol % CO2 to 70 mol % CO2, 20 mol % O2 to 35 mol % O2, 1 mol % Ar to 2 mol % Ar, 5 mol % N2 to 20 mol % N2, and 2 mol % water to 40 mol % water.

As yet another example, the mixing device 7 can be configured for formation of synthetic air SA that can include less than 15 mol % N2 or less than 10 mol % N2. Preferably, the N2 concentration in the formed synthetic air SA is minimized or otherwise kept relatively low (e.g. below 20 mol % or below 15 mol %). However, N2 may ingress into a combustion chamber due to imperfect seals and/or exposure of the combustion chamber to atmospheric air that may occur due to other non-perfect sealed conditions over time. This can be a particular issue in the event the flue gas FG used for formation of the synthetic air is flue gas that is formed from the combustion in the combustion chamber and recycled as recycled flue gas RF for providing as the source of the flue gas FG for the synthetic air formation. In such a situation, while the N2 concentration for the formed synthetic air SA can initially be about 0 mol % or between 10 mol % and 0 mol % or between 5 mol % and 0 mol %, the N2 concentration within the synthetic air SA may increase over time to a higher concentration (e.g. between 5 mol % and 15 mol % or between 5 mol % and 20 mol %).

In other situations (e.g. a newer combustion device facility), seals and other potential sites of ambient air ingress may not be a significant issue. In such a situation, the formed synthetic air SA can be maintained so that the N2 concentration of the synthetic air is under 20 mol %, preferably under 12 mol %, and most preferably between 10 mol % and 0 mol %. In some embodiments, it is contemplated that the synthetic air SA that is formed can have 0 mol % N2 or only a trace amount of N2 (e.g. between 0 mol % N2 and 1 mol % N2).

We have found that the use of synthetic air as the oxidant in the combustion chamber of the combustion device 3 can facilitate low NOx formation during combustion of a fuel. Use of the synthetic air having low N2 concentrations can help avoid the presence of nitrogen for formation of NOx. Further, the synthetic air SA can include relatively high concentrations of CO2 and water, which can help further inhibit NOx formation. We surprisingly found that embodiments of the apparatus 1 that utilize synthetic air SA having such low N2 concentrations and relatively high water and CO2 concentrations can provide a substantial reduction of NOx formation (e.g. provide between a 60% and 95% reduction in NOx formation or provide between a 75% and 95% reduction in NOx formation as compared to use of air as the oxidant or oxygen enriched air as the oxidant (e.g. oxidant flows having between 70 mol % N2 and 79 mol % N2 and between 20 mol % O2 and 28 mol % O2) in some embodiments).

Also, even though N2 in synthetic air SA can be much lower than that in ambient air, it can still be in a sufficient amount in an O2-enriched atmosphere to expect high NOx emissions near the flame where temperature may increase as compared to atmospheric combustion. However, we have surprisingly found that in such a condition low NOx can be produced via combustion using an embodiment of synthetic air SA having low N2 that is below 20 mol % N2 but higher than 5 mol % N2.

The synthetic air SA can be fed to the combustion device 3 after being formed via oxygen injection into flue gas via the mixing device 7 in different ways. For example, the synthetic air SA can be fed into the combustion device via annular conduits of at least one burner 3b that is fluidly connected to the mixing device 7 via a burner feed conduit between the mixing device 7 and the burner 3b. As another example, the synthetic air SA can be fed to the combustion device 3 via one or more combustion chamber inlets that are fluidly connected to the mixing device 7 via at least one synthetic air feed conduit 6 (shown in broken line) connected between the mixing device 7 and the combustion device 3.

We have also found that the utilization of synthetic air having a high concentration of CO2 can be beneficial for use in carbon capture to avoid CO2 emissions and/or form at least one CO2 product stream from operations of the combustion device 3. For example, flue gas output from the combustion device 3 via flue gas output conduit 3e can be fed to a carbon capture apparatus 11 for processing of the flue gas to form at least one CO2 product stream 11p. In some embodiments, a first portion of the output flue gas can be fed to the carbon capture apparatus 11 and a second portion of the output flue gas can be fed to the mixing device 7 as a source of gas having CO2 via a flue gas recycle conduit 3r connected between the mixing device 7 and the flue gas output conduit 3e of the combustion device 3. The first portion of the flue gas fed to the carbon capture apparatus 11 can be between 30% and 70% of the flue gas output from the combustion device and the second portion of the flue gas recycled back to the mixing device 7 can be the balance of the flue gas (e.g. between 70% and 30% of the flue gas output from the combustion device 3). For example, during operation, the proportion of output flue gas recycled back to the mixing device 7 can vary from a substantial portion (e.g. close to 70% of it) to a minimal portion (e.g. 30% of it or 35%, etc.) and the portion of the output flue gas fed to the carbon capture apparatus 11 can correspondingly vary as well (e.g. be close to 30% of the output flue gas when a substantial portion is recycled and be close to or at 70% of the output flue gas when the minimal portion of the flue gas is recycled back to the mixing device 7).

For instance, when the CO2 content of the synthetic air SA is high, the proportion of the flue gas fed to the carbon capture apparatus 11 may be higher (e.g. between 50% to 70% of the output flue gas) to facilitate a more efficient capturing of carbon dioxide from the flue gas. Conversely, when the flue gas concentration may have a lower content of CO2, the proportion of the flue gas fed to the carbon capture apparatus 11 can be lower (e.g. closer to 30% of the output flue gas).

The proportional split of the flue gas formed from combustion in the combustion device that is passed through the flue gas output conduit 3e for carbon capture and recycling of flue gas to the mixing device 7 can be adapted to other proportions as well. For example, the portions can be 50% each or the first portion fed to the carbon capture apparatus 11 can be between 40% and 60% of the flue gas output from the combustion device 3 via flue gas output conduit 3e and the remaining portion of the flue gas can be recycled back to the mixing device 7 as the recycled flue gas RF. In yet other embodiments, some of the flue gas can be routed differently (e.g. another portion of flue gas can be provided for venting of flue gas or a first portion of the flue gas can be vented instead of being fed to the carbon capture apparatus 11 and the second portion can be recycled back to the mixing device 7).

We have found that obtaining a high content of CO2 within the flue gas formed from combustion with the combustion device 3 can permit the CO2 to be separated from the flue gas more efficiently and allow a greater recovery of the CO2. For example, some embodiments can facilitate a capturing and recovery of 95% or more than 95% of the CO2 within the flue gas formed from the combustion within the combustion chamber of the combustion device 3. Also, the concentration of CO2 within the formed CO2 product stream(s) 11p out puttable from the carbon capture apparatus 11 can be high (e.g. 95 mol % CO2, between 95 mol % CO2 and 100 mol % CO2, greater than or equal to 90 mol % CO2 and less than 100 mol % CO2, etc.).

Embodiments of the apparatus 1 for reduced nitrogen oxide formation during combustion can implement an embodiment of a process for reduced nitrogen oxide formation during combustion. Examples of embodiments of such a process can be appreciated from FIG. 2. In a first step S1, synthetic air SA can be formed by mixing flue gas from at least one source of gas having CO2 4 (e.g. CO2 or CO2-rich flue gas) and/or flue gas recycled from the combustion device 3 with oxygen from at least one source of oxygen. Such formation can occur via a mixing device 7 injecting oxygen for mixing with the flue gas, for example.

In some embodiments, prior to this first step S1, there can be an initial step S0 (shown in broken line) that can include determining that the combustion device 3 has started up operation to form sufficient flue gas for use in forming the synthetic air SA for initiating the formation of the synthetic air of the first step S1. As discussed above, such an initial step S0 can occur in situations where the combustion device 3 may be designed for an initial start up of the combustion process by use of ambient air or oxygen enriched air. The use of synthetic air SA can then be switched to as the source of oxidant so that ambient air or oxygen enriched air may no longer be utilized in the combustion device as an oxidant.

In a second step S2, the formed synthetic air SA can be fed to a combustion device 3 as an oxidant for combustion of a fuel in a combustion chamber of the combustion device to form combustion products that can permit reduced nitrogen oxide formation to occur via the combustion.

Embodiments of the process can also include other steps. For example, some embodiments can include a third step S3 (shown in broken line), in which a portion of the formed flue gas that includes the combustion products can be emitted from the combustion device 3 for capturing carbon dioxide from that flue gas via at least one carbon capture device (e.g. carbon capture apparatus 11). This type of carbon capture can be provided at the same time some of the flue gas is also recycled back to a mixing device 7 for forming the synthetic air SA as discussed above. The proportions of flue gas fed to a carbon capture apparatus 11 and recycled to the mixing device 7 for formation of synthetic air SA can be adjusted to account for various operational conditions, which can include the content of CO2 within the flue gas as discussed above, for example. The proportional split can also include forming of other portions of flue gas for routing to other locations (e.g. forming of a third portion for venting, forming of another portion for feeding to another process device or industrial plant element, etc.).

As discussed above, it was surprisingly found that embodiments of the process and apparatus 1 can provide a substantial reduction in NOx formation. Also, embodiments can provide an improved ability to capture CO2 for providing of at least one product stream 11p of CO2 that can have a high CO2 concentration (e.g. greater than 90 mol % CO2, greater than 95 mol % CO2, etc. as discussed above).

For example, embodiments can be provided so that NOx formation is in a range of 15 mg/Nm³ of NOx to greater than 0 mg/Nm³ of NOx when the combustion device 3 operates at full rate operation (e.g. full designed capacity, 100% operational capacity consistent with combustion device operational settings and design, etc.). Other embodiments can be configured so that NOx formation is in a range of 12 mg/Nm³ of NOx to greater than 0.2 mg/Nm³ of NOx or 10 mg/Nm³ of NOx to greater than 0.4 mg/Nm³ of NOx. Yet other embodiments can be configured so that NOx formation is in a range of 6.1 mg/Nm³ of NOx to 0.8 mg/Nm³ of NOx or 6.1 mg/Nm³ of NOx to greater than 0 mg/Nm³ of NOx. Such reduced NOx formation can be provided for when the combustion device 3 operates at full rate operation. Embodiments can also provide such reduced NOx formation when the combustion device 3 operates at lower rates of operation as well.

### Experimental Results

Confidential testing was performed to evaluate embodiments of our apparatus 1 and process for reduced nitrogen oxide formation during combustion. This testing showed that substantial NOx reductions and improved carbon capture can be provided by embodiments of our apparatus 1 and process.

In conducted testing, an industrial air staged not pre-mixed down fired burner with 1.1 MW duty was fired with a blend of two fuels, natural gas and pressure swing adsorption (PSA) off gas. The composition of the feed of fuel fed to the combustion device for this experiment is shown below in Table 1:

TABLE 1
Fuel composition for a first set of testing

| Fuel Constituents | Concentration (Mol %) |
|---|---|
| Natural gas | 22 |
| Hydrogen (H2) | 25 |
| CO2 | 51 |
| N2 | 2 |

The fuel composition had a molecular weight of 27.2, a lower heating value (LHV) of 9,107 KJ/kg and a theoretical air requirement of 2.8 on a volume to volume basis (vol/vol) for complete combustion.

Ambient air was utilized as an oxidant for comparison with an embodiment using synthetic air SA. The ambient air had typical air concentrations (e.g. 20-21 mol % oxygen, 78-79 mol % nitrogen, trace amounts of CO2, water, and Ar, etc.). The synthetic air composition used in the testing is shown in the below Table 2:

TABLE 2
Synthetic Air composition for the first set of testing

| Synthetic Air Constituents | Concentration (Mol %) |
|---|---|
| CO2 | 35 |
| Ar | 2 |
| O2 | 26 |
| N2 | 8 |
| Water (H2O) | 29 |

In the conducted experimentation, when air was utilized as the oxidant, NOx emissions of 25 parts per million by volume dry (ppmvd) was produced (determined on a dry basis). In contrast, use of the synthetic air provided a 90% reduction in NOx emissions (e.g. 2.5 ppmvd NOx was produced). The NOx reduction was determined on a dry basis.

Additional testing was performed to evaluate different fuel compositions and use of different oxygen compositions in the synthetic air to evaluate how that may affect NOx formation. With oxygen content was adjusted to 22 mol % and 28 mol %, the NOx emissions were found to be 2.8 mg/Nm³ and 2.6 mg/Nm³, respectively, from the combustion of the fuel. As used herein, Nm³ is a normal cubic meter, which is a volume of gas that occupied 1 cubic meter (m³) under conditions in which the gas is absolutely dry, at a temperature of 0° C. and at an absolute pressure of 1 atm (which is 1.01325 bar).

In contrast, the use of air with the same fuel resulted in formation of 65.7 mg/Nm³ of NOx from the combustion of the fuel. This further shows that use of the synthetic air SA in embodiments of our process and apparatus can provide a greater than 95% reduction in NOx.

Testing was also conducted to evaluate the impact burner duty could have on NOx emission using synthetic air SA as the oxidant for the fuel. Our testing found that at 40% burner duty, only 6.1 mg/Nm³ of NOx would be formed, which provides about an 80% reduction in NOx as compared to ambient air being used as the oxidant. For other higher duties, it was found that NOx formation would be under 3 mg/Nm³. For example, at a duty of 60%, synthetic air use resulted in NOx formation of 2.6 mg/Nm³ and at 80% and 120% duties, the use of synthetic air as the oxidant resulted in NOx formation of 0.8 mg/Nm³. This type of low NOx formation provides a substantial reduction in NOx formation as compared to ambient air (e.g. greater than an 80% reduction to a greater than 95% reduction in NOx). This conducted testing also showed that the use of synthetic air helped provide a reduction in flame length by about 10% as compared to use of ambient air as the oxidant. Our conducted testing also showed that varying oxygen content within the synthetic air from 22 mol % to 28 mol % had no meaningful impact on adiabatic flame temperature or flame length and emissions.

These experimental results were very surprising. In an oxygen enriched atmosphere with a relatively large amount of nitrogen, higher NOx emissions would have been expected near the flame where temperature may increase as compared to atmospheric combustion. While thermal and chemical action of water are known to help inhibit NOx formation, the results of the conducted testing showed that the NOx emissions using synthetic air SA are substantially and surprisingly reduced and can provide such a substantial reduction along a wide range of N2, CO2, and water compositions within the synthetic air. In fact, NOx emissions can be substantially reduced even without water being present or steam being injected.

Even though N2 in synthetic air can be much lower than that in ambient air, it can still be in a sufficient amount for an O2-enriched atmosphere to expect high NOx emissions near the flame where temperature may increase as compared to atmospheric combustion. However, our experimental results show that even when such N2 is present in the synthetic air SA (even though that N2 content may be lower than N2 in ambient air or oxygen enriched air), low NOx is obtained via combustion of a fuel with the synthetic air SA as the oxidant, which is a surprising finding.

Over time, a combustion device 3 in use can result in air ingress into the combustion device. This can occur due to seals wearing and other factors. Embodiments of our apparatus and process in which the source of gas having CO2 for the synthetic air is recycled flue gas RF that is recycled from the combustion device 3 may result in the synthetic air SA having a higher N2 content over time as a result of this condition. While that may occur, it was still surprisingly found that even after a long period of use, the N2 concentration of the synthetic air SA could be under 20 mol % after a substantial continuous period of operation and still provide a reduction in NOx formation of between 95% and 75% over the duration of operation. And such a reduction in NOx can also be provided with improved carbon capture as discussed above. Further, the reduction in NOx and improved CO2 recovery can be provided without having to incur additional costs or operational risk associated with catalytic reduction (e.g. no need for risking an ammonia slip as discussed above, etc.). The improved reduction in NOx can also be provided irrespective of whether advanced burners are utilized or not in the combustion device 3.

Embodiments of our process, apparatus, and system can be adapted for different design criteria. For example, it should be appreciated that other embodiments can utilize different types of conduit arrangements, fuel storage tanks or fuel pipelines, oxygen storage tanks or oxygen producing process units, combustion device arrangements, and/or types of fuel (e.g. natural gas, oil, diesel, coal, hydrogen, etc.,).

It should also be appreciated that other modifications can also be made to meet a particular set of criteria for different embodiments of the apparatus 1 or process. For instance, the arrangement of valves, piping, and other conduit elements (e.g., conduit connection mechanisms, tubing, seals, valves, etc.) for interconnecting different units of the apparatus for fluid communication of the flows of fluid between different elements (e.g., compressors, fans, valves, conduits, etc.) can be arranged to meet a particular plant layout design that accounts for available area of the apparatus, sized equipment of the apparatus, and other design considerations. As another example, the flow rate, pressure, and temperature of the fluid passed through the various apparatus or system elements can vary to account for different design configurations and other design criteria.

As yet another example, embodiments of the apparatus 1 and process can each be configured to include process control elements positioned and configured to monitor and control operations (e.g., temperature and pressure sensors, flow sensors, an automated process control system having at least one work station that includes a processor, non-transitory memory and at least one transceiver for communications with the sensor elements, valves, and controllers for providing a user interface for an automated process control system that may be run at the work station and/or another computer device of the plant, etc.). It should be appreciated that embodiments can utilize a distributed control system (DCS) for implementation of one or more processes and/or controlling operations of an apparatus or process as well.

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of the process, apparatus, system, and methods of making and using the same have been shown and described above, it is to be distinctly understood that the invention is not limited thereto but may be otherwise variously embodied and practiced within the scope of the following claims.

What is claimed is:

1. An apparatus for reduced nitrogen oxide formation during combustion, the apparatus comprising:
a mixing device configured to mix flue gas and oxygen to form a synthetic air for feeding to a combustion device as an oxidant for combustion of a fuel fed to the combustion device, the mixing device positionable to receive a gas from at least one source of gas having carbon dioxide (CO2) and/or flue gas output from the combustion device that is recycled to the mixing device, the mixing device positioned to receive the oxygen from at least one source of oxygen; and
wherein the synthetic air has a concentration of oxygen (O2) of between 20 mole percent (mol %) O2 and 40 mol % O2, has a concentration of nitrogen (N2) of between 20 mol % N2 and 0 mol % N2, and a concentration of CO2 of at least 30 mol % CO2.

2. The apparatus of claim 1, wherein the synthetic air comprises between 2 mol % water and 40 mol % water.

3. The apparatus of claim 2, wherein the synthetic air has a CO2 concentration of between 30 mol % CO2 and 70 mol % CO2.

4. The apparatus of claim 3, wherein the synthetic air has a pre-selected ratio of water to CO2 of between 0.5 and 1.0.

5. The apparatus of claim 1, comprising:
the combustion device, the combustion device configured to receive the synthetic air output from the mixing device as an oxidant for combustion of a fuel to form flue gas.

6. The apparatus of claim 5, comprising:
a carbon capture apparatus positioned to receive a first portion of the flue gas output from the combustion device.

7. The apparatus of claim 6, wherein the mixing device is positioned to receive a second portion of the flue gas output from the combustion device for forming the synthetic air.

8. The apparatus of claim 7, wherein the second portion of the flue gas is between 30% and 70% of the flue gas output from the combustion device and a balance of the flue gas is the first portion of the flue gas.

9. The apparatus of claim 1, wherein the synthetic air is formed such that combustion of the fuel at full rate operation with the synthetic air results in formation of nitrogen oxides (NOx) that is no more than 15 mg/Nm³ of NOx and is also greater than 0 mg/Nm³ of NOx, wherein Nm³ is a normal cubic meter.

10. The apparatus of claim 1, wherein the at least one source of oxygen comprises oxygen from an air separation unit (ASU), vacuum swing adsorption (VSA) unit, and/or a storage tank configured to retain oxygen.

11. The apparatus of claim 1, wherein the synthetic air is formed so that combustion of the fuel at full rate operation with the synthetic air results in formation of nitrogen oxides (NOx) that is no more than 6.1 mg/Nm³ of NOx and is also greater than 0 mg/Nm³ of NOx, wherein Nm³ is a normal cubic meter.

12. A process for reduced nitrogen oxide formation during combustion, the process comprising:
forming a synthetic air by mixing a gas having carbon dioxide (CO2) and/or flue gas recycled from a combustion device with oxygen from at least one source of oxygen, the synthetic air having between 0 mole percent (mol %) nitrogen (N₂) and 20 mol % N2;
feeding the formed synthetic air to the combustion device as an oxidant for combustion of a fuel in a combustion chamber of the combustion device.

13. The process of claim 12, comprising:
feeding a portion of flue gas formed via the combustion of the fuel in the combustion chamber of the combustion device to a mixing device for formation of the synthetic air.

14. The process of claim 12, comprising:
feeding a first portion of flue gas formed via the combustion of the fuel in the combustion chamber of the combustion device to a carbon capture apparatus to form at least one carbon dioxide product stream.

15. The process of claim 14, comprising:
feeding a second portion of flue gas formed via the combustion of the fuel in the combustion chamber of the combustion device to a mixing device for formation of the synthetic air.

16. The process of claim 15, comprising feeding the oxygen to the mixing device for the forming of the synthetic air.

17. The process of claim 12, wherein the synthetic air has a concentration of oxygen (O2) of between 20 mol % O2 and 40 mol % O2, has a concentration of N2 of between 20 mol % N2 and 0 mol % N2, a concentration of CO2 of at least 30 mol % CO2, and a concentration of water of between 2 mol % water and 40 mol % water.

18. The process of claim 17, comprising:
combusting the fuel in presence of the synthetic air as an oxidant for the combusting of the fuel such that formation of nitrogen oxides (NOx) from combusting of the fuel during full rate operation is no more than 15 mg/Nm³ of NOx and is also greater than 0 mg/Nm³ of NOx, wherein Nm³ is a normal cubic meter.

19. The process of claim 12, comprising:
combusting the fuel in presence of the synthetic air as an oxidant for the combusting of the fuel such that formation of nitrogen oxides (NOX) from combusting of the fuel during full rate operation is no more than 6.1 mg/Nm³ of NOx and is also greater than 0 mg/Nm³ of NOx, wherein Nm³ is a normal cubic meter.

20. An apparatus for reduced nitrogen oxide formation during combustion, the apparatus comprising:
a mixing device configured to mix flue gas and oxygen to form a synthetic air for feeding to a combustion device as an oxidant for combustion, the mixing device positionable to receive the flue gas from at least one source of gas having carbon dioxide (CO2) and/or flue gas output from the combustion device that is recycled to the mixing device, the mixing device positioned to receive the oxygen from at least one source of oxygen; and
wherein the synthetic air has a concentration of oxygen (O2) of between 20 mole percent (mol %) O2 and 40 mol % O2, has a concentration of nitrogen (N2) of between 20 mol % N2 and 0 mol % N2, and a concentration of CO2 of between 30 mol % CO2 and 80 mol % CO2;
the combustion device connected to the mixing device to receive the synthetic air from the mixing device as the oxidant for combustion of a fuel, the combustion device having at least one burner and a flue gas outlet conduit for outputting flue gas formed from the combustion;
a carbon capture apparatus positioned to receive a first portion of the flue gas from the flue gas outlet conduit to form at least one CO2 product stream having a concentration of CO2 between 90 mol % CO2 and 100 mol % CO2; and
the mixing device positioned to receive a second portion of the flue gas from the flue gas outlet conduit to form the synthetic air, the synthetic air being formable such that combustion of the fuel at full rate operation with the synthetic air results in formation of nitrogen oxides (NOx) that is no more than 15 mg/Nm³ of NOx and is also greater than 0 mg/Nm³ of NOx, wherein Nm³ is a normal cubic meter; and
wherein the first portion is between 30% and 70% of the flue gas and the second portion is a remaining portion of the flue gas that is not passed to the carbon capture apparatus.
